(19) United States
(12) Patent Application Publication
(10) Pub. No.: US 2004/0137227 A1
(43) Pub. Date: Jul. 15, 2004

(54) Polyester fiber

(76) Inventors: Toshiyuki Masuda, Takasago-shi (JP); Toshihiro Kowaki, Settsu-shi (JP)

Correspondence Address: KENYON & KENYON, 1500 K STREET, N.W., SUITE 700, WASHINGTON, DC, 20005, US

(21) Appl. No.: 10/472,847

(22) PCT Filed: Apr. 11, 2002
(86) PCT No.: PCT/JP02/03593

(30) Foreign Application Priority Data
Apr. 16, 2001 (JP) 2001-117405
Apr. 17, 2001 (JP) 2001-117819
Apr. 18, 2001 (JP) 2001-119797

(51) Int. Cl. D02G 3/00; B32B 27/34

(52) U.S. Cl. 428/395

(57) ABSTRACT

A polyester fiber having improved dripping resistance during burning can be provided by a polyester fiber made of a polyester composition containing a layer compound treated with at least one kind selected from a polyether compound and a silane compound, and a thermoplastic polyester resin. The present invention also relates to a polyester fiber made of a polyester composition comprising a layer compound treated with a water-soluble or water-miscible phosphorus flame retardant, and a thermoplastic polyester resin.

### TECHNICAL FIELD

The present invention relates to a polyester fiber made of a polyester composition containing a layer compound, which has improved dripping resistance during burning.

### BACKGROUND ART

Fibers made of polyester comprising polyethylene terephthalate or mainly polyethylene terephthalate have high melting point and high elastic modulus and are excellent in heat resistance and chemical resistance. Therefore, these fibers are widely used in curtains, carpets, clothes, blankets, sheet materials, table clothes, upholstery materials, wall materials, artificial hairs for wig, hair wig and false hair, automobile interior materials, outdoor reinforcing materials, and protective nets.

However, polyester fibers made of polyethylene terephthalate typically are combustible material and are easy to burn, and also melt-dripped during the burning to cause burn injury by the molten fibers, and burn injury and fire spread due to melt-dipping fire, even if fire at the ignition portion was extinguished.

Various trials of improving the burning resistance of polyester fibers have been made. For example, a method of copolymerizing a polyester resin with a flame-retardant monomer having a phosphorus atom and a method of impregnating polyester fibers with a flame retardant have been known. As the former method of copolymerizing the flame-retardant monomer, for example, Japanese Examined Patent Publication No. 55-41610 proposes a method of copolymerizing a phosphorus compound having good heat stability in which a phosphorus atom is a ring member, Japanese Examined Patent Publication No. 53-13479 proposes a method of copolymerizing carboxyphosphinic acid, and Japanese Unexamined Patent Publication No. 11-124732 proposes a method of incorporating a phosphorus compound in or copolymerizing the phosphorus compound with a polyester containing polyallylate. As the latter method of impregnating the flame retardant, for example, Japanese Examined Patent Publication No. 3-57990 proposes a method of impregnating polyester fibers with a halogenated cycloalkane compound in the form of fine particles and Japanese Examined Patent Publication No. 1-24913 proposes a method of impregnating with a bromine atom-containing alkylcyclohexane.

Flame-retardant polyester fibers obtained by using these methods have not only problems such as poor spinnability, deterioration of mechanical properties of fibers and evolution of a toxic gas during burning, but also problems caused by melt dripping like polyester fibers provided with no flame retardancy because an fire extinguishing mechanism is based on melt dripping.

Further a trial of preventing melt dripping during burning is made. For example, Japanese Unexamined Patent Publication No. 5-9808 proposes a method of preventing melt dripping by irradiating polyester fibers containing a phosphorus flame retardant and an auxiliary crosslinking agent with electron beam; Japanese Unexamined Patent Publication No. 7-166421 proposes a method of preventing melt dripping by carbonizing fibers impregnated with a phosphorus compound which accelerates carbonization; and Japanese Unexamined Patent Publication Nos. 8-170223 and 9-268423 propose a method of preventing melt dripping during burning by impregnating fibers with a silicone oil having a functional group.

An object of the present invention is to provide a flame-retardant polyester fiber which maintains fiber physical properties such as heat resistance, toughness of conventional polyester fibers, and is not melt-dripped during burning.

### DISCLOSURE OF THE INVENTION

To achieve the object described above, the present inventors have intensively studied, and thus the present invention has been completed.

The present invention provides a polyester fiber made of a polyester composition containing a layer compound treated with at least one kind selected from a polyether compound and a silane compound, and a thermoplastic polyester resin.

Preferably, the polyester fiber further contains a phosphorus flame retardant.

The thermoplastic polyester resin is preferably a thermoplastic copolymer polyester resin copolymerized with a reactive phosphorus flame retardant.

The polyether compound preferably has a cyclic hydrocarbon group.

The polyether compound is preferably represented by the following general formula (1):

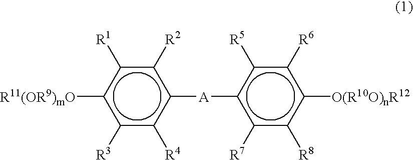

wherein -A- represents —O—, —S—, —SO—, —SO₂—, —CO—, an alkylene group having 1 to 20 carbon atoms, or an alkylidene group having 6 to 20 carbon atoms; any of R¹ to R⁸ represent a hydrogen atom, a halogen atom, or a monovalent hydrocarbon group having 1 to 5 carbon atoms; any of R⁹ and R¹⁰ represent a divalent hydrocarbon group having 1 to 5 carbon atoms; any of R¹¹ and R¹² represent a hydrogen atom or a monovalent hydrocarbon group having 1 to 20 carbon atoms, and may be mutually the same or different; and m and n represent a repeating unit number of an oxyalkylene unit and satisfy the expression: 2≦m+n≦50.

The silane compound is preferably represented by the following general formula (2):

YnSiX₄₋ₙ (2)

wherein n represents an integer of 0 to 3; Y represents a hydrocarbon group having 1 to 25 carbon atoms, or an organic functional group composed of a hydrocarbon group having 1 to 25 carbon atoms and a substituent; X represents a hydrolyzable group and/or a hydroxyl group; and n Y and n X may be the same or different.

An average layer thickness of the layer compound is preferably 500 Å or less.

A maximum layer thickness of the layer compound is preferably 2000 Å or less.

An average aspect ratio (ratio of layer length to layer thickness) of the layer compound in the resin composition is preferably from 10 to 300.

The layer compound is preferably a layer silicate.

The phosphorus flame retardant is preferably at least one kind of a compound selected from the group consisting of a phosphate compound, a phosphonate compound, a phosphinate compound, a phosphine oxide compound, a phosphonite compound, a phosphinite compound, and phosphine compound.

Furthermore, the present invention relates to a polyester fiber made of a polyester composition comprising a layer compound treated with a water-soluble or water-miscible phosphorus flame retardant, and a thermoplastic polyester resin.

An average layer thickness of the layer compound is preferably 500 Å or less.

A maximum layer thickness of the layer compound is preferably 2000 Å or less.

An average aspect ratio (ratio of layer length to layer thickness) of the layer compound in the resin composition is preferably from 10 to 300.

The layer compound is preferably a layer silicate.

The water-soluble or water-miscible phosphorus flame retardant is preferably at least one kind of a compound selected from the group consisting of diethyl-N,N-bis(2-hydroxyethyl)aminomethylphosphonate, tris(hydroxyalkyl)phosphine, tris(hydroxyalkyl)phosphine oxides, alkyl-bis(hydroxyalkyl)phosphine oxides, alkyl-bis(hydroxycarbonylalkyl)phosphine oxides, dipolyoxyalkylenehydroxyalkyl phosphate, alkyl(hydroxycarbonylalkyl)phosphinic acids, and condensed phosphate esters.

### BEST MODE FOR CARRYING OUT THE INVENTION

The thermoplastic polyester resin used in the present invention is a conventionally known arbitrary thermoplastic polyester resin which is obtained by reacting an acid component containing a dicarboxylic acid compound and/or an ester forming derivative of dicarboxylic acid as a main component with a diol component containing a diol compound and/or an ester forming derivative of the diol compound as a main component.

The above-mentioned phrase “containing as a main component” means that the each proportion in the acid or diol component is 70% or more, and preferably 80% or more, and the upper limit is 100%.

Specific examples of the thermoplastic polyester resin include polyethylene terephthalate, polypropylene terephthalate, polybutylene terephthalate, polyhexamethylene terephthalate, polycyclohexane-1,4-dimethylene terephthalate, polyneopentyl terephthalate, polyethylene isophthalate, polyethylene naphthalate, polybutylene naphthalate, and polyhexamethylene naphthalate and the like. Also, a copolymer polyester prepared by using two or more kinds of acid components and/or diol components used in the preparation of these resins can be listed.

Among the above-mentioned thermoplastic polyester resins, polyethylene terephthalate, polybutylene terephthalate, polycyclohexane-1,4-dimethylene terephthalate and polyethylene naphthalate are preferable.

The thermoplastic polyester resin can be used alone, or two or more kinds of thermoplastic polyester resins having different compositions or components and/or thermoplastic polyester resins having different intrinsic viscosities can be used in combination.

With respect to a molecular weight of the thermoplastic polyester resin, an intrinsic viscosity as measured at 25° C. using a mixed solvent of phenol and tetrachloroethane in a weight ratio of 5:5 is preferably within a range from 0.3 to 1.5 (dl/g), more preferably from 0.3 to 1.2 (dl/g), and most preferably from 0.4 to 1.0 (dl/g). When the intrinsic viscosity is less than 0.3 (dl/g), it becomes difficult to perform melt spinning and fusion between short fibers tends to occur during the drawing and heat treatment processes or processing into a product because of too low melt viscosity. On the other hand, when the intrinsic viscosity exceeds 1.5 (dl/g), it tends to become difficult to perform melt spinning because of too high melt viscosity.

Examples of the acid component used in the copolymer ester include terephthalic acid, isophthalic acid, 2,6-naphthalenedicarboxylic acid, 4,4′-bisphenyldicarboxylic acid, 4,4′-diphenyletherdicarboxylic acid, 4,4′-diphenylmethanedicarboxylic acid, 4,4′-diphenylsulfonedicarboxylic acid, 4,4′-diphenylisopropylidenedicarboxylic acid, adipic acid, azelaic acid, dodecane diacid, and sebacic acid, and substituted products and derivatives thereof can also be used.

Examples of the diol component include ethylene glycol, propylene glycol, butyleneglycol, hexyleneglycol, neopentyl glycol, and 1,4-cyclohexane dimethanol.

Also oxy acids such as p-oxybenzoic acid and p-hydroxybenzoic acid, and ester-forming derivatives thereof can also be used.

Examples of the layer compound used in the present invention include one or more kinds of compound selected from the group consisting of silicate, phosphate such as zirconium phosphate, titanate such as potassium titanate, tungstate such as sodium tungstate, uranate such as sodium uranate, vanadate such as potassium vanadate, molybdate such as magnesium molybdate, niobate such as potassium niobate, and graphite. Among these layer compounds, layer silicate is preferable in view of availability and handlability.

The layer silicate is mainly composed of a tetrahedral sheet of silicon oxide and an octahedral sheet of metal hydroxide and includes, for example, smectite clay mineral and swellable mica.

The smectite clay mineral is a natural or synthetic clay mineral represented by the following general formula (3):

X¹_{0.2-0.6}Y¹₂₋₃Z¹₄O₁₀(OH)₂.nH₂O (3)

wherein X¹ represents at least one kind selected from the group consisting of K, Na, ½ Ca and ½ Mg; Y¹ represents at least one kind selected from the group consisting of Mg, Fe, Mn, Ni, Zn, Li, Al and Cr; Z¹ represents at least one kind selected from the group consisting of Si and Al; H₂O represents a water molecule bonded to an interlayer ion; and n drastically varies depending on the interlayer ions and relative humidity. Specific examples of the smectite clay mineral include montmorillonite, beidellite, nontronite, saponite, iron saponite, hectorite, sauconite, stevensite, bentonite, and substituted products, derivatives and mixtures thereof. Among these smectite clay minerals, montmorillonite, hectorite and bentonite are preferable in view of ply separation of the layer compound in case of treating the layer compound with a polyol compound or a silane compound, and fine dispersibility of the layer compound in case of kneading with the thermoplastic resin.

The swellable mica is a natural or synthetic mica represented by the following general formula (4):

X²_{0.5-1.0}Y²₂₋₃(Z²₄O₁₀)(F, OH)₂ (4)

wherein X² represents at least one kind selected from the group consisting of Li, Na, K, Pb, Ca, Ba and Sr; Y² represents at least one kind selected from the group consisting of Mg, Fe, Mn, Ni, Li and Al; Z² represents at least one kind selected from the group consisting of Si, Ge, Fe, B and Al. The swellable mica has a property that it swells in water, a polar solvent compatible with water in arbitrary proportion, or a mixed solvent containing water and the polar solvent. Examples thereof include lithium type taeniolite, sodium type taeniolite, lithium type tetrasilicate mica, sodium type tetrasilicate mica, and substituted products, derivatives and mixtures thereof. Among these, lithium type tetrasilicate mica and sodium type tetrasilicate mica are preferable in view of ply separation of the layer compound in case of treating the layer compound with a polyol compound or a silane compound, and fine dispersibility of the layer compound in case of kneading with the thermoplastic resin.

Some compounds corresponding to the vermiculites can also be used as a kind of the swellable micas. Compounds corresponding to the vermiculites include the trioctahedral type and the dioctahedral type. The trioctahedral type refers to an octahedral sheet wherein an octahedron comprising six OH⁻ or O₂₋ ions and metal ions surrounded by the ions extend in a two-dimensional manner while sharing edges, all metal ion positions of the octahedron including divalent metal ions being filled, while the dioctahedral type refers to an octahedral sheet including trivalent metal ions, one-third of the metal ion positions are vacant.

The layer silicate has a tabular crystal structure, and two perpendicular axes in the plane of the tabular crystal are referred to as an a-axis and a b-axis and an axis, which perpendicularly intersects the plane of the tabular crystal, is referred to as a c-axis. In the present invention, a high-purity clay mineral comprising layers which are regularly stacked in a direction of c-axis is preferable, but a so-called mixed layer mineral comprising plural kinds of crystal structures with a random period can also be used.

These layer compounds may be used alone, or two or more kinds of them may be used in combination. Among these, montmorillonite, bentonite, hectorite, or swellable mica having sodium ions between layers is preferable.

The layer silicate used in the present invention is treated with at least one kind selected from the group consisting of a polyether compound and a silane compound.

The polyether compound refers to a compound whose main chain is a polyoxyalkylene such as polyoxyethylene or polyoxyethylene-polyoxypropylene copolymer, the number of a repeating unit being about 2 to 100. The polyether compound may have a substituent such as hydrocarbon group, group bonded through an ester bond, epoxy group, amino group, carbonyl group, amide group, or halogen atom in the side chain and/or the main chain.

The polyether compound is preferably soluble in water, or a polar solvent containing water. Specifically, the solubility in 100 g of water at room temperature is preferably 1 g or more, more preferably 5 g or more, and most preferably 10 g or more. When the solubility is less than 1 g, ply separation of the layer compound becomes insufficient when the layer compound is treated, and fine dispersibility tends to become insufficient in case of kneading with the thermoplastic resin. Examples of the polar solvent as used herein include alcohols such as methanol and ethanol; glycols such as ethylene glycol and propylene glycol; ketones such as acetone and methyl ethyl ketone; ethers such as diethyl ether and tetrahydrofuran; amide compounds such as N,N-dimethylformamide; and nitrogen-containing compounds such as pyridine.

Specific examples of the polyether compound used in the present invention include polyalkylene glycols such as polyethylene glycol, polypropylene glycol, and polyethylene glycol-polypropylene glycol; polyalkylene glycol monoethers such as polyethylene glycol monomethyl ether and polyethylene glycol monoethyl ether; polyalkylene glycol diethers such as polyethylene glycol dimethyl ether, polypropylene glycol diethyl ether, and polyethylene glycol diglycidyl ether; polyalkylene glycol monoesters such as polyethylene glycol (meth)acrylate; polyalkylene glycol diesters such as polyethylene glycol di(meth)acrylate; amines such as bis(polyethylene glycol)butylamine and bis(polyethylene glycol)octylamine; and modified bisphenols such as polyethylene glycol bisphenol A ether and ethylene oxide-modified bisphenol A di(meth)acrylate. Among these polyether compounds, modified bisphenols such as polyethylene glycol bisphenol A ether and ethylene oxide-modified bisphenol A di(meth)acrylate are preferable in view of fine dispersibility of the layer compound in case of kneading with the thermoplastic resin.

Among the ether compounds of the present invention, an ether compound having a cyclic hydrocarbon group is preferable and an ether compound having an aromatic hydrocarbon group is more preferable, and a layer compound represented by the following general formula (1):

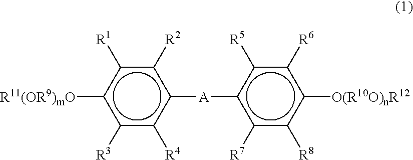

wherein -A- represents —O—, —S—, —SO—, —SO₂—, —CO—, an alkylene group having 1 to 20 carbon atoms, or an alkylidene group having 6 to 20 carbon atoms; any of R¹ to R⁸ represent a hydrogen atom, a halogen atom, or a monovalent hydrocarbon group having 1 to 5 carbon atoms; any of R⁹ and R¹⁰ represent a divalent hydrocarbon group having 1 to 5 carbon atoms; any of R¹¹ and R¹² represent a hydrogen atom or a monovalent hydrocarbon group having 1 to 20 carbon atoms, and may be the same or different; and m and n represent a repeating unit number of an oxyalkylene unit and satisfy the expression: 2−m+n≦50, is preferable in view of the dispersibility and heat stability of the layer compound.

The amount of the polyether compound can be controlled so as to enhance the affinity between the layer compound and the thermoplastic resin, and the dispersibility of the layer compound in the polyester fiber. Therefore, the amount of the polyether compound is not limited to a specific numerical value, but is preferably from 0.1 to 200 parts by weight, more preferably from 0.3 to 160 parts by weight, and most preferably from 0.5 to 120 parts by weight, based on 100 parts by weight of the layer compound. When the amount is less than 0.1 parts by weight, the effect of finely dispersing the layer compound tends to become insufficient. Even if the amount exceeds 200 parts by weight, the effect is not enhanced and, therefore, it is not necessary to use 200 parts by weight or more of the layer compound.

In the present invention, it is possible to use a silane compound represented by the following general formula (2):

YnSiX₄₋ₙ (2)

wherein n represents an integer of 0 to 3; Y represents a hydrocarbon group having 1 to 25 carbon atoms, or an organic functional group composed of a hydrocarbon group having 1 to 25 carbon atoms and a substituent; X represents a hydrolyzable group and/or a hydroxyl group; and n Y and n X may be the same or different, in the treatment of the layer compound.

Specific examples of the silane compound include compounds having an alkyl group, such as methyltrimethoxysilane, 2-ethylhexyltrimethoxysilane, and decyltrimethoxysilane; compounds having a carbon-carbon double bond, such as vinyltrichlorosilane, vinyltriacetoxysilane, and γ-methacryloxypropyltrimethoxysilane; compounds having an ether bond, such as γ-polyoxyethylenepropyltrimethoxysilane and 2-ethoxyethyltrimethoxysilane; compounds having an epoxy group, such as γ-glycidoxypropyltrimethoxysilane; and compounds having an amino group, such as γ-aminopropyltrimethoxysilane. Among these silane compounds, γ-polyoxyethylenepropyltrimethoxysilane, 2-hydroxyethyltrimethoxysilane, γ-glycidoxypropyltrimethoxysilane and γ-aminopropyltrimethoxysilane are preferable in view of fine dispersibility of the layer compound in case of kneading with the thermoplastic resin.

Substituted products and derivatives of the silane compounds can also be used. These silane compounds can be used alone, or two or more kinds of them can be used in combination.

The amount of the silane compound can be controlled so as to sufficiently enhance the affinity between the layer compound and the thermoplastic resin, and the dispersibility of the layer compound. If necessary, plural kinds of silane compounds having different kinds of functional groups can be used in combination. Therefore, the amount of the silane compound is not limited to a specific numerical value, but is preferably from 0.1 to 200 parts by weight, more preferably from 0.3 to 160 parts by weight, and most preferably from 0.5 to 120 parts by weight, based on 100 parts by weight of the layer compound. When the amount is less than 0.1 parts by weight, the effect of finely dispersing the layer compound tends to become insufficient. Even if the amount exceeds 200 parts by weight, the effect is not enhanced and, therefore, it is not necessary to use 200 parts by weight or more of the layer compound.

In the present invention, the method of treating with at least one kind selected from the group consisting of a polyether compound and a silane compound is not specifically limited and, for example, the following method can be used.

First, the layer compound and a dispersion medium are mixed with stirring. The dispersion medium refers to water, or a polar solvent containing water. The method of mixing the layer compound and a dispersion medium with stirring is not specifically limited and, for example, it can be carried out using a conventionally known wet stirrer. Examples of the wet stirrer include high-speed stirrer for stirring by rotating a stirring blade at high speed, wet mills for wet grinding of a sample in spacing between a rotor and a stator under high shear, mechanical grinders utilizing a hard medium, wet collision grinders for allowing a sample to collide at a high speed using a jet nozzle, and ultrasonic grinder using ultrasonic wave. In case of mixing more efficiently, a rotational speed is controlled to 1000 rpm or higher, preferably 1500 rpm or higher, and more preferably 2000 rpm or higher. Alternatively, a shear rate is controlled to 500 (1/second) or higher, preferably 1000 (1/second) or higher, and more preferably 1500 (1/second) or higher. The upper limit of the rotational speed is preferably about 25000 rpm and the upper limit of the shear rate is preferably about 500000 (1/second) or higher. Since the effect is not enhanced even if stirring is carried out at the rotational speed or shear rate higher than the upper limit, it is not necessary to perform stirring at the value higher than the upper limit. And the time for mixing is preferably 1 minute or more. After adding a polyether compound or a silane compound, sufficient mixing is carried out while stirring is continued under the same conditions. The temperature during mixing is commonly room temperature, but may be optionally heated. The maximum temperature during heating is not specifically limited as far as it is lower than a decomposition temperature of the polyether compound or silane compound and is also lower than a boiling point of the dispersion medium. The mixture is dried and then optionally formed into powders.

The content of the layer compound is preferably from 0.1 to 30 parts by weight, more preferably from 0.3 to 25 parts by weight, and most preferably from 0.5 to 20 parts by weight, based on 100 parts by weight of the thermoplastic polyester resin. When the content is less than 0.1 parts by weight, the reinforcing effect due to the addition of the layer compound tends to become insufficient. On the other hand, when the content exceeds 30 parts by weight, fiber physical properties such as toughness tend to be lowered.

The structure of the layer compound dispersed in the polyester fiber of the present invention is quite different from a μm-sized coagulated structure comprising mutually stacked layers of the layer compound before use. That is, layers of the layer structures are separated and independently fragmentated with each other. As a result, the layer compound is finely dispersed in the form of an independent sheet and the number increases by far as compared with the layer compound before use. The dispersion state of the layer compound in the form of a sheet is expressed by an equivalent area circle diameter [D], an aspect ratio (ratio of layer length to layer thickness), the number of dispersed particles [N], a maximum layer thickness and an average layer thickness described hereinafter.

First, the equivalent area circle diameter [D] is defined as a diameter of a circle having the same area as that of the respective layer compounds dispersed in various forms in the image obtained under a microscope on the same image. In that case, the layer compound having the circle having the same area [D] of 3000 Å or less preferably accounts for 20% or more, more preferably 40% or more, and most preferably 60% or more, among the layer compounds dispersed in the resin composition. When the proportion of the layer compound having the circle having the same area [D] of 3000 Å or less is less than 20%, the effect of preventing melt dripping of the polyester fiber during burning and the effect of improving fiber physical properties tend to become insufficient. An average value of the circle having the same area [D] of the layer compound in the polyester fiber of the present invention is preferably 5000 Å or less, more preferably 40000 Å or less, and most preferably 3500 Å or less. When the average value of the circle having the same area [D] exceeds 5000 Å, the effect of preventing melt dripping of the polyester fiber during burning and the effect of improving fiber physical properties tend to become insufficient.

The average aspect ratio is defined as an average value of a ratio of a layer length to a layer thickness of the layer compound dispersed in the resin composition. In this case, the average aspect ratio of the layer compound in the polyester fiber of the present invention is preferably from 10 to 300, preferably from 15 to 300, and most preferably from 20 to 300. When the average aspect ratio of the layer compound is less than 10, the effect of preventing melt dripping of the polyester fiber during burning and the effect of improving fiber physical properties tend to become insufficient. The effect is not enhanced when the average aspect ratio exceeds 300, therefore it is not necessary to increase the average aspect ratio 300 or more

The number of dispersed particles [N] is defined as the number of dispersed particles per unit weight of the layer compound in an area of 100 μm² of the resin composition. In this case, [N] is preferably 30 or more, more preferably 45 or more, and most preferably 60 or more. When [N] is less than 30, the effect of preventing melt dripping of the polyester fiber during burning and the effect of improving fiber physical properties tend to become insufficient. Although there is no upper limit of [N], the effect is not when [N] exceeds about 1000. Therefore, it is not necessary to increase [N].

The average layer thickness is defined as a number average value of a layer thickness of the layer compound dispersed in the form of a sheet. In this case, the average layer thickness of the layer compound is preferably 500 Å or less, more preferably 450 Å or less, and most preferably 400 Å or less. When the average layer thickness exceeds 500 Å, the effect of preventing melt dripping of the polyester fiber during burning and the effect of improving fiber physical properties tend to become insufficient. Although there is no lower limit of the average layer thickness, the average layer thickness is preferably more than 50 Å.

The maximum layer thickness is defined as a maximum value of a layer thickness of the layer compound dispersed in the form of a sheet. In this case, the maximum layer thickness of the layer compound is preferably 2000 Å or less, more preferably 1800 Å or less, and most preferably 1500 Å or less. When the average layer thickness exceeds 2000 Å, the effect of preventing melt dripping of the polyester fiber during burning and the effect of improving fiber physical properties tend to become insufficient. Although there is no lower limit of the maximum layer thickness, the average layer thickness is preferably more than 100 Å.

The additive and/or reactive phosphorus flame retardant used in the present invention are not specifically limited and conventionally used phosphorus flame retardants can be used. Typical examples thereof include organophosphorus compounds such as phosphate compound, phosphonate compound, phosphinate compound, aphosphine oxide compound, phosphonite compound, phosphinite compound, and phosphine compound.

Specific examples of the additive phosphorus flame retardant include condensed phosphate ester compounds represented by the following general formula (5):

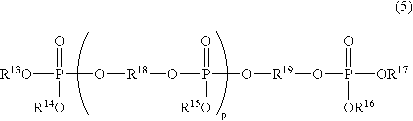

wherein R¹³ to R¹⁷ represent a monovalent aromatic hydrocarbon group or an aliphatic hydrocarbon group; R¹⁸ and R¹⁹ represent a divalent aromatic hydrocarbon group; p represents 0 to 15; and p R¹⁵ and R¹⁸ may be the same or different, for example, trimethyl phosphate, triethyl phosphate, tributyl phosphate, tri(2-ethylhexyl)phosphate, triphenyl phosphate, tricresyl phosphate, trixylenyl phosphate, tris(isopropylphenyl)phosphate, tris(phenylphenyl)phosphate, trinaphthyl phosphate, cresylphenyl phosphate, xylenyldiphenyl phosphate, triphenylphosphine oxide, tricresylphosphine oxide, diphenyl methanephosphonate, diethyl phenyphosphonate, resorcinolpolyphenyl phosphate, resorcinolpoly(di-2,6-xylyl)phosphate, bisphenol A polycresyl phosphate, and hydroquinonepoly(2,6-xylyl)phosphate.

Specific examples of the reactive phosphorus flame retardant include diethyl-N,N-bis(2-hydroxyethyl)aminomethylphosphonate, 2-methacryloyloxyethyl acid phosphate, diphenyl-2-methacryloyloxyethyl phosphate, tris(3-hydroxypropyl)phosphine, tris(4-hydroxybutyl)phosphine, tris(3-hydroxypropyl)phosphine oxide, tris(3-hydroxybutyl)phosphine oxide, 3-(hydroxyphenylphosphinoyl)propionic acid, alkyl-bis(hydroxyalkyl)phosphine oxides represented by the general formula (6), alkyl-bis(hydroxycarbonylalkyl)phosphine oxides represented by the general formula (7) and derivatives thereof, dipolyoxyalkylenehydroxyalkyl phosphonate represented by the general formula (8), and alkyl(hydroxycarbonylalkyl)phosphinic acids represented by the general formula (9) and derivatives thereof.

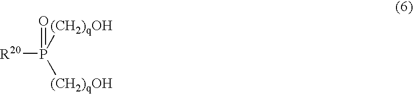

wherein R²⁰ represents an aliphatic hydrocarbon group having 1 to 20 carbon atoms or an aromatic hydrocarbon group having 6 to 12 carbon atoms, and q represents an integer of 1 to 12

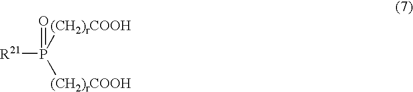

wherein R²¹ represents an aliphatic hydrocarbon group having 1 to 20 carbon atoms or an aromatic hydrocarbon group having 6 to 12 carbon atoms, and r represents an integer of 1 to 11

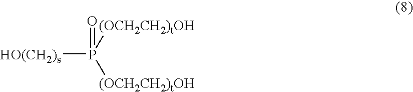

wherein s and t represent an integer of 1 to 20

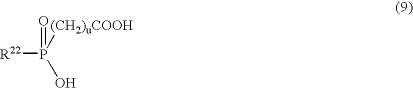

wherein R²² represents an aliphatic hydrocarbon group having 1 to 20 carbon atoms or an aromatic hydrocarbon group having 6 to 12 carbon atoms, and u represents an integer of 1 to 11

These phosphorus flame retardants can be used alone, or two or more kinds of them can be used in combination.

The amount of the phosphorus flame retardant is from 0.01 to 15 parts by weight, more preferably from 0.05 to 10 parts by weight, and most preferably from 0.1 to 8 parts by weight, in terms of the amount of a phosphorus atom, based on 100 parts by weight of the thermoplastic polyester. When the amount is less than 0.01 parts by weight, it becomes difficult to obtain the flame retardant effect. On the other hand, when the amount exceeds 15 parts by weight, mechanical properties tends to be impaired. The reactive phosphorus flame retardant may be used after adding to the thermoplastic resin and may be used as a flame-retardant copolymer polyester after reacting with the thermoplastic resin. The copolymer polyester can be produced by a known method, and preferably a method of mixing dicarboxylic acid and a derivative thereof, a diol component and a derivative thereof and a reactive flame retardant, and polycondensing the mixture. Also, preferred is a method of depolymerizing a thermoplastic polyester using a diol component such as ethylene glycol and depolymerizing the thermoplastic polyester again in the presence of a reactive flame retardant to obtain a copolymer.

Furthermore, the present invention relates to a polyester fiber made of a polyester composition comprising a layer compound treated with a water-soluble or water-miscible phosphorus flame retardant, and a thermoplastic polyester resin.

Specific examples of the water-soluble or water-miscible phosphorus flame retardant include diethyl-N,N-bis(2-hydroxyethyl)aminomethylphosphonate, tris(hydroxyalkyl)phosphines represented by the formula (10), tris(hydroxyalkyl)phosphine oxides represented by the formula (11), alkyl-bis(hydroxyalkyl)phosphine oxides represented by the formula (12), alkyl-bis(hydroxycarbonylalkyl)phosphine oxides represented by the formula (13), dipolyoxyalkylenehydroxyalkyl phosphates represented by the formula (14), alkyl(hydroxycarbonylalkyl)phosphines represented by the formula (15), and condensed phosphate esters represented by the general formula (16).

(HO(CH₂)ₙ)₃P (10)

wherein m represents an integer of 1 to 8

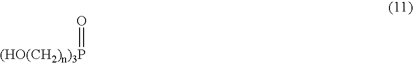

wherein m represents an integer of 1 to 8

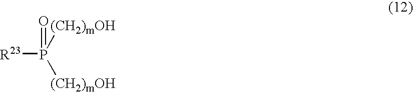

wherein R²³ represents a monovalent hydrocarbon group having 1 to 20 carbon atoms, and m represents an integer of 1 to 8

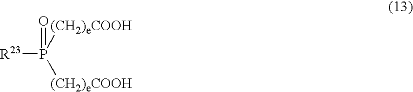

wherein R²³ represents a monovalent hydrocarbon group having 1 to 20 carbon atoms, and e represents an integer of 1 to 7

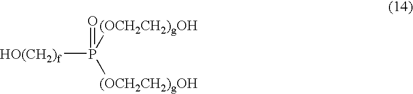

wherein f represents an integer of 1 to 8, and g represents an integer of 1 to 40

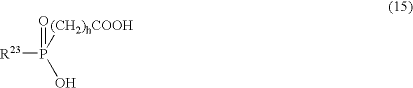

wherein R²³ represents a monovalent hydrocarbon group having 1 to 20 carbon atoms, and h represents an integer of 1 to 7

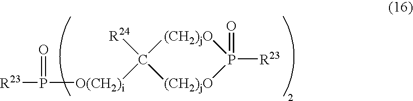

wherein R²³ and R²⁴ represent a monovalent hydrocarbon group having 1 to 20 carbon atoms, and i and j represent an integer of 1 to 8

Among the water-soluble or water-miscible phosphorus flame retardant of the present invention, the compound represented by the general formula (12), (14) or (16) is preferable.

The amount of the water-soluble or water-miscible phosphorus flame retardant can be controlled so as to enhance the affinity between the layer compound and the thermoplastic resin, and the dispersibility of the layer compound in the polyester fiber. Therefore, the amount of the phosphorus flame retardant is not limited to a specific numerical value, but is preferably from 0.1 to 200 parts by weight, more preferably from 0.3 to 160 parts by weight, and most preferably from 0.5 to 120 parts by weight, based on 100 parts by weight of the layer compound. When the amount is less than 0.1 parts by weight, the effect of finely dispersing the phosphorus flame retardant tends to become insufficient. Even if the amount exceeds 200 parts by weight, the effect is not enhanced and, therefore, it is not necessary to use 200 parts by weight or more of the layer compound.

In the present invention, the method of treating the layer compound with the water-soluble or water-miscible phosphorus flame retardant is not specifically limited and, for example, the layer compound can be treated in the same manner as in case of treating with the polyether compound or silane compound.

The method of preparing the layer compound of the present invention is not specifically limited and include, for example, a method of melt-kneading a thermoplastic polyester and a layer compound using various conventional kneaders. Examples of the kneader include single screw extruder, twin screw extruder, roll, Banbury mixer, and kneader. Particularly, a kneader of high shear efficiency is preferable.

The order of kneading is not specifically limited and the thermoplastic polyester resin, the additive phosphorus flame retardant and the layer compound may be charged simultaneously in the kneader and melt-kneaded. Alternatively, the additive phosphorus flame retardant may be added after kneading the thermoplastic polyester resin and the layer compound, or the layer compound and the additive phosphorus flame retardant may be added to the previously molten thermoplastic polyester resin and kneading the mixture.

In case of the reactive additive phosphorus flame retardant, it is preferably copolymerized with the thermoplastic polyester resin.

The polyester fiber of the present invention can be produced by a conventional melt-spinning method using the polyester composition containing the layer compound. After controlling the temperature of an extruder, a gear pump and a spinneret within a range from 250 to 320° C., the polyester composition was melt-spun and a spun yarn was passed through a heating cylinder, cooled to a glass transition point and then taken off at a speed of 5 to 5000 m/min to obtain a take-off undrawn yarn. Also the fineness can be controlled by cooling the spun yarn in a water bath containing cooling water. The temperature and length of the heating cylinder, the temperature and blowing amount of cooling air, the temperature of the cooling water bath, the cooling time and the take-off speed can be appropriately controlled by the ejection amount and the number of pores of the spinneret.

The resulting undrawn yarn may be subjected to hot drawing by a two stage method of drawing after winding the undrawn yarn or a direct spin drawing method of continuously drawing without winding. Hot drawing is carried out by a one-stage drawing method or a two- or multi-stage drawing method. As a heating means in the hot drawing, a heating roller, a heating plate, a steam-jet apparatus and a hot water bath can be used in combination.

The resulting drawn yarn is optionally subjected to a heat treatment using a heating roller, a heating plate or a steam-jet apparatus.

When using the polyester fiber of the present invention as an artificial hair, it may be used in combination with the other artificial hair made of modacrylic, polyvinyl chloride, or nylon. When using as the artificial hair, the fineness is preferably from 20 to 70 dtex.

The polyester fiber of the present invention can be optionally subjected to a delustering treatment such as alkali reduction treatment.

The processing conditions of the polyester fiber of the present invention are not specifically limited and the polyester fiber can be processed in the same manner as in a conventional polyester resin. However, it is preferable to use pigments, dyes and auxiliaries which are excellent in weatherability and flame retardancy.

If necessary, the polyester fiber of the present invention can contain various additives such as flame retardants, heat-resisting agents, photostabilizers, fluorescent agents, antioxidants, delustering agents, antistatic agents, pigments, plasticizers, and lubricants.

The polyester fiber provided by the present invention can be preferably used in various fields of curtains and clothes and is particularly suited for use in artificial hairs such as wig, hair wig and false hair because it has high melting point and high elastic modulus and has flame retardancy while maintaining excellent heat resistance and chemical resistance, and can prevent melt dripping during burning.

### EXAMPLES

The present invention will be described in detail by way of examples, but is not limited by the following examples.

The characteristic values were measured by the following procedures.

(Intrinsic Viscosity of Polyester)

Using a 1:1 mixture of phenol and tetrachloroethane as a solvent, a relative density at 25° C. of a solution having a concentration of 0.05 g/dl was measured by an Ubbelohde viscometer and an intrinsic viscosity was calculated by the equation (17):

$$[ η ] = {lim}_{c \to 0} {η}_{sp} / C = {lim}_{c \to 0} ( {η}_{rel} - 1 ) / C = {lim}_{c \to 0} ( η - {η}_{0} ) / {η}_{0} C \qquad ( 17 )$$

where η represents a viscosity of a solution, η₀ represents a viscosity of a solvent, ηᵣₑₗ represents a relative viscosity, ηₛₚ represents a specific viscosity, [η] represents an intrinsic viscosity, and C represents a concentration of a solution.

(Measurement of Layer Clay Compound in Dispersed State)

Using an ultra-thin section having a thickness of 50 to 100 μm, the dispersed state of a layer compound was observed by a transition electron microscope (JEM-1200EX manufactured by JEOL, hereinafter referred to as TEM) at an acceleration voltage of 80 kV and a magnification of 40,000 to 1,000,000, and then a microphotograph was taken. In the TEM microphotograph, after selecting any region where 100 or more dispersed particles exist, the layer thickness, the layer length, the number of particles ([N]) and the equivalent area circle diameter [D] were measured manually by a scaled rule or processing using an image analyzer PIASIII (manufactured by InterQuest Corporation). The equivalent area circle diameter [D] was measured by processing using the image analyzer PIASIII (manufactured by InterQuest Corporation). The value [N] was measured in the following manner. First, the number of particles of the layer compound existing in the selected region was determined on the TEM microphotograph. Separately, an ash content of the resin composition originating in the layer compound was measured. The value obtained by dividing the number of particles by the ash content and calculating based on the area of 100 μm² was taken as a value [N]. The average layer thickness is a number average value of layer thicknesses of the respective layer compounds, and the maximum layer thickness is a maximum value of layer thicknesses of the respective layer compounds. When dispersed particles are too large to be observed by TEM, the value [N] was determined in the same manner as described above using an optical microscope (Optical Microscope BH-2 manufactured by OLYMPUS OPTICAL CO., LTD.). If necessary, samples were melted at 250 to 270° C. using a hot stage THM600 (manufactured by LINKAM Co.) and the state of the dispersed particles was measured in a molten state. The aspect ratio of the dispersed particles, which are not dispersed in a tabular form, was replaced by a value of major axis/minor axis. The term “major axis” as used herein means a long side of a rectangle, assuming that the rectangle is a rectangle having a minimum area among rectangles circumscribed with the objective particles in the TEM image. The term “minor axis” means a short side of the rectangle having a minimum area.

(Toughness)

Using INTESCO, Model 201 (manufactured by INTESCO Co.), a tensile strength and a tensile elongation of a filament were measured. A sample having a length of 20 mm was made by fixing both ends (10 mm) of a filament having a length of 40 mm to a mount (thin paper) provided with a double-coated tape, followed by air-drying overnight. The resulting sample was mounted to a testing machine and the toughness were measured by testing under the conditions of a temperature of 24° C., a humidity of 80% or less, a load of 1/30 gf X fineness (denier) and a testing speed of 20 mm/min. The test was repeated 10 times under the same conditions and an average value was taken as the toughness of the filament.

(Limiting Oxygen Index)

After weighing a filament of 16 cm/0.25 g, ends of the filament were slightly fixed using a double-coated tape and the filament was twisted using a twisting device. After sufficiently twisting, the filament was folded in two and two filaments are twisted. Both ends were fixed using a cellophane tape to make the total length of 7 cm. After pre-drying at 105° C. for 60 minutes, the sample was further dried in a desiccator for 30 or more minutes. An oxygen concentration of the dried sample was adjusted to a predetermined oxygen concentration and, after 40 seconds, the sample was ignited from the upper portion using an igniter whose flame was controlled to 8 to 12 mm. After ignition, the igniter was removed. It was examined whether or not the sample was burnt in a length of 5 cm or more, or the oxygen concentration after burning for 3 minutes was examined. The test was repeated under the same conditions three times and a limiting oxygen index was determined.

(Dripping Properties)

Filaments were bundled so that the total fineness becomes 5000 dtex, and then the bundle was vertically suspended after fixing to a stand while grasping one end. After bringing a flame in length of 20 mm close to the bundle of filaments, the bundle was burnt in a length of 100 mm. The number of drips was counted. Samples where the number of drips was 5 or less were rated “good (◯)”, samples where the number of drips was 6 to 10 were rated “ordinary (Δ)”, and samples where the number of drips was 11 or more were rated “poor (X)”.

(Melting Point and Crystallinity)

Using a differential scanning calorimeter (DSC-220C manufactured by Seiko Instruments Inc., a melting point and a crystallinity were measured. After weighing about 10 mg of a filament, the filament was put in a sample pan and then heated at a heating rate of 20° C./min within a range from 30 to 290° C. Then, an exothermic or endothermic change in heat quantity was measured and a melting point and a fusion heat quantity were determined. Based on the fusion heat quantity, the crystallinity was calculated by using the following equation (18):

χ_{c}=ΔHexp/ΔH⁰ (18)

where ΔHexp represents a found fusion heat quantity, and ΔH⁰ represents a fusion heat quantity of a complete crystal PET (136 J/g).

### Production Example 1

In a wet mill (MILL MIX MM2, manufactured by Nippon Seiki Co., Ltd.), 5 L of deionized water was charged and 350 g of swellable mica (SOMASIF ME100, manufactured by CO-OP Chemical Co., Ltd.) was slowly added while stirring at 5000 rpm. After stirring was continued for 5 minutes, 105 g of polyethylene glycol containing a bisphenol A unit on a main chain (Bisol 18EN, manufactured by TOHO Chemical Industry Co., Ltd.) was slowly added, followed by continuous stirring for 10 to 15 minutes. The resulting slurry was taken out from the mill, dried at 120° C. for 48 hours and then formed into powders using a grinder to obtain 450 g of a treated swellable mica (hereinafter referred to as a treated mica A).

### Production Example 2

In the same manner as in Production Example 1, except that the swellable mica was replaced by bentonite (Kunipia F, manufactured by Koromine Industries Co., Ltd.), 450 g of a treated bentonite (hereinafter referred to as a treated bentonite) was obtained.

### Production Example 3

In the same manner as in Production Example 1, except that the polyethylene glycol containing a bisphenol A unit on a main chain was replaced by γ-(polyoxyethylene)propyltrimethoxysilaen (A-1230, manufactured by Nippon Unicar Co., Ltd.), 445 g of a treated swellable mica (hereinafter referred to as a treated mica B) was obtained.

### Production Example 4

In a pressure container equipped with a nitrogen introducing tube, a solvent distilling-off tube, a pressure gauge and an inner temperature measuring portion, 2910 g of dimethyl terephthalate, 4686 g of 1,4-cyclohexanediol and 0.9 g of cobalt acetate as a catalyst for transesterification were charged and the mixture was heated to 140° C. while stirring in a nitrogen atmosphere. The eliminated methanol was distilled off by raising the reaction temperature to 230° C. under normal pressure over 5 hours. After a theoretical amount of methanol was distilled off, excess 1,4-cyclohexanediol was distilled off under slightly reduced pressure. To the resulting bis(1,4-cyclohexanedimethyl)terephthalate and its oligomer, 0.9 g of germanium dioxide as a polymerization catalyst was added. The polycondensation reaction was carried out by raising the reaction temperature to 280° C. over 60 minutes and reducing the inner pressure to 1 Torr or less over 60 minutes and stirring was continued until the intrinsic viscosity of the melt becomes 0.6 to obtain polycyclohexane-1,4-dimethylene terephthalate.

### Production Example 5

In a pressure container equipped with a nitrogen introducing tube, a solvent distilling-off tube, a pressure gauge and an inner temperature measuring portion, 2880 g of polyethylene terephthalate, 490 g of bis(2-hydroxyethyl)ether of bisphenol A (Bisol 2EN, manufactured by TOHO Chemical Industry Co., Ltd.), 600 g of ethylene glycol and 0.9 g of antimony trioxide were charged and the mixture was heated to 190° C. while stirring in a nitrogen atmosphere. After maintaining at 190° C. for 30 minutes, excess ethylene glycol was distilled off by raising the reaction temperature to 280° C. over one hour. The polycondensation reaction was carried out by reducing the inner pressure to 1 Torr or less over 30 minutes and stirring was continued until the intrinsic viscosity of the melt becomes 0.6 to obtain a copolymer polyester A.

### Production Example 6

In the same manner as in Production Example 5, except that 490 g of bis(2-hydroxyethyl)ether of bisphenol A was replaced by 1435 g of 1,4-cyclohexanedimethanol, a copolymer polyester B was obtained.

### Production Example 7

In the same manner as in Production Example 5, except that 490 g of bis(2-hydroxyethyl)ether of bisphenol A was replaced by 167 g of n-butyl-bis(3-hydroxypropyl)phosphine oxide, a copolymer polyester C was obtained.

### Production Example 8

In the same manner as in Production Example 5, except that 490 g of bis(2-hydroxyethyl)ether of bisphenol A was replaced by 150 g of bis(2-hydroxyethyl)hydroxymethyl phosphonate, a copolymer polyester D was obtained.

### Production Examples 9 to 12

In a wet mill (MILL MIX MM2, manufactured by Nippon Seiki Co., Ltd.), 5 L of deionized water was charged and 350 g of swellable mica (SOMASIF ME100, manufactured by CO-OP Chemical Co., Ltd.) was slowly added while stirring at 5000 rpm. After stirring was continued for 5 minutes, 175 g of each of phosphorus flame retardants shown in Table 1 was slowly added, followed by continuous stirring for 10 to 15 minutes. The resulting slurry was taken out from the mill, dried at 120° C. for 48 hours and then formed into powders using a grinder to obtain 515 g of treated swellable micas (hereinafter referred to treated micas C to F).

### Examples 1 to 30

A mixture of a thermoplastic polyester resin dried to water content of 100 ppm or less and a treated layer mixture shown in Tables 2, 3 and 4 was melt-kneaded using a twin screw extruder (TEX44, manufactured by Japan Steel Works Co., Ltd.) at a predetermined temperature of 230 to 320° C., pelletized and then dried to water content of 100 ppm or less. Using a no-bent type 30 mm single screw extruder (manufactured by Shinko Machinery Co., Ltd.), the molten polymer was ejected through a spinning spinneret provided with a round-section nozzle pore having a nozzle diameter of 0.5 mm, cooled in a water bath (water temperature: 30° C.) disposed 30 mm under the spinneret, and then taken up at a take-up rate of 100 m/min to obtain an undrawn yarn. The resulting undrawn yarn was drawn by 5 times in a warm water bath at 90° C., taken up at a take-up rate of 100 m/min using a heat roll heated to 180° C. and then subjected to a heat treatment to obtain polyester fibers having a single filament fineness of about 50 dtex.

TABLE 1

| | Name of compounds | Structural Formula |
|---|---|---|
| Preparation Example 9 | n-butyl-bis(3-hydroxypropyl)phosphine oxide | 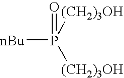 |
| Preparation Example 10 | n-butyl-bis(2-hydroxy- carbonylethyl)phosphine oxide | 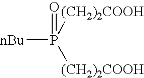 |
| Preparation Example 11 | bis(2-hydroxyethyl)hydroxymethyl phosphonate | 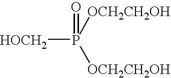 |
| Preparation Example 12 | | 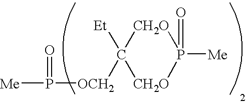 |

TABLE 2

| | Inherent | Examples | | | | | | | | | |
|---|---|---|---|---|---|---|---|---|---|---|---|
| | viscosity (IV) | 1 | 2 | 3 | 4 | 5 | 6 | 7 | 8 | 9 | 10 |
| Polyethylene | 0.61 | 90 | 90 | 90 | 60 | 70 | | | 50 | | |
| terephthalate*1 | | | | | | | | | | | |
| Polybutylene | 1.20 | | | | 30 | | | | | | |
| terephthalate*2 | | | | | | | | | | | |
| Polyallylate*3 | 0.60 | | | | | 20 | | | | | |
| Polycyclohexane-1,4- | 0.65 | | | | | | 90 | 90 | 40 | | |
| dimethylene terephthalate | | | | | | | | | | | |
| Copolymer polyester A | 0.64 | | | | | | | | | 90 | |
| Copolymer polyester B | 0.62 | | | | | | | | | | 90 |
| Treated mica A | — | 10 | | | | 10 | 10 | | 10 | 10 | 10 |
| Treated mica B | — | | 10 | | 10 | | | | | | |
| Treated bentonite | — | | | 10 | | | | 10 | | | |

*1Bellpet EFG-10 manufactured by Kanebo Gosen, Ltd.
*2Novadol 50200S manufactured by Mitsubishi Engineering-Plastics Corporation
*3U-100 manufactured by UNITIKA Ltd.

TABLE 3

| | Inherent | Examples | | | | | | | | | |
|---|---|---|---|---|---|---|---|---|---|---|---|
| | viscosity (IV) | 11 | 12 | 13 | 14 | 15 | 16 | 17 | 18 | 19 | 20 |
| Polyethylene terephthalate*1 | 0.61 | 95 | 90 | 90 | 70 | 50 | | | | | |
| Polyallylate*2 | 0.60 | | | | 20 | | | | | 40 | |
| Polyethylene | 0.60 | | | | | 40 | | | | | |
| terephthalate/polyallylate | | | | | | | | | | | |
| alloy*3 | | | | | | | | | | | |
| Copolymer polyester A | 0.58 | | | | | | 90 | | | | |
| Copolymer polyester B | 0.65 | | | | | | | 90 | | | |
| Copolymer polyester C | 0.64 | | | | | | | | 90 | 50 | |
| Copolymer polyester D | 0.62 | | | | | | | | | 90 | |
| Treated mica A | — | 5 | 10 | | | 10 | 10 | 10 | 10 | 10 | 10 |
| Treated mica B | — | | | 10 | 10 | | | | | | |
| 1,3-phenylenebis(dixylene | — | | 10 | 10 | 10 | 10 | 10 | 10 | | | |
| phosphate) | | | | | | | | | | | |
| tris(phenylphenyl)phosphate | — | 10 | | | | | | | | | |

*1Belipet EFG-10 manufactured by Kanebo Gosen, Ltd.
*2U-100 manufactured by UNITIKA Ltd.
*3U-8000 manufactured by UNITIKA Ltd.

TABLE 4

| | Inherent | Examples | | | | | | | | | |
|---|---|---|---|---|---|---|---|---|---|---|---|
| | viscosity (IV) | 21 | 22 | 23 | 24 | 25 | 26 | 27 | 28 | 29 | 30 |
| Polyethylene terephthalate*1 | 0.61 | 90 | 90 | 90 | 70 | 60 | 50 | 50 | | | 40 |
| Polybutylene terephthalate*2 | 1.20 | | | | 20 | | | | | | |
| Polyallylate*3 | 0.60 | | | | | 30 | | | | | |
| Polyethylene | 0.60 | | | | | | 40 | 40 | | | |
| terephthalate/polyallylate | | | | | | | | | | | |
| alloy*4 | | | | | | | | | | | |
| Copolymer polyester A | 0.62 | | | | | | | | 90 | | |
| Copolymer polyester B | 0.64 | | | | | | | | | 90 | 50 |
| Treated mica C | — | 10 | | | | 10 | 10 | | | | |
| Treated mica D | — | | 10 | | | | | 10 | | | |
| Treated mica E | — | | | 10 | | | | | 10 | 10 | |
| Treated mica F | — | | | | 10 | | | | | | 10 |

*1Belipet EFG-10 manufactured by Kanebo Gosen, Ltd.
*2Novadol 5010R5 manufactured by Mitsubishi Engineering-Plastics Corporation
*3U-100 manufactured by UNITIKA Ltd.
*4U-8000 manufactured by UNITIKA Ltd.

### Comparative Example 1

Using a no-bent type 30 mm single screw extruder (manufactured by Shinko Machinery Co., Ltd.), the molten polymer of polyethylene terephthalate (Bellpet EFG-10, manufactured by Kanebo Gosen, Ltd.) was ejected through a spinning spinneret provided with a round-section nozzle pore having a nozzle diameter of 0.5 mm, cooled in a water bath (water temperature: 30° C.) disposed 30 mm under the spinneret, and then taken up at a take-up rate of 100 m/min to obtain an undrawn yarn. The resulting undrawn yarn was drawn by 5 times in a warm water bath at 90° C., taken up at a take-up rate of 100 m/min using a heat roll heated to 180° C. and then subjected to a heat treatment to obtain a polyester fiber having a single filament fineness of about 50 dtex.

### Comparative Example 2

In the same manner as in Comparative Example 1, except that a mixture of 5000 g of polyethylene terephthalate (Bellpet EFG-10, manufactured by Kanebo Gosen, Ltd.) and 500 g of 1,3-phenylenebis(dixylenyl phosphate) was used, a polyester fiber having a single filament fineness of about 50 dtex was obtained.

### Comparative Example 3

In the same manner as in Comparative Example 1, except that a mixture of 4500 g of polyethylene terephthalate (Bellpet EFG-10, manufactured by Kanebo Gosen, Ltd.), 500 g of a swellable mica (ME100, manufactured by CO-OP Chemical Co., Ltd.) and 500 g of 1,3-phenylenebis(dixylenyl phosphate) was used, a polyester fiber having a single filament fineness of about 50 dtex was obtained.

### Comparative Example 4

In the same manner as in Comparative Example 1, except that a mixture of 4500 g of polyethylene terephthalate (Bellpet EFG-10, manufactured by Kanebo Gosen, Ltd.) and 500 g of a swellable mica (ME100, manufactured by CO-OP Chemical Co., Ltd.) was used, a polyester fiber having a single filament fineness of about 50 dtex was obtained.

With respect to the fibers obtained in Examples 1 to 30 and Comparative Examples 1 to 4, the dispersed state of the layer compound, the toughness, the melting point, the crystallinity, the limiting oxygen index (LOI), and the dripping properties were measured. The results are shown in Tables 5 to 8.

TABLE 5

| | Examples | | | | | | | | | |
|---|---|---|---|---|---|---|---|---|---|---|
| | 1 | 2 | 3 | 4 | 5 | 6 | 7 | 8 | 9 | 10 |
| Average of [D] (Å) | 2200 | 2450 | 2150 | 2430 | 2220 | 2260 | 2380 | 2170 | 2190 | 2230 |
| [N] (numbers/wt % · 100 μm²) | 85 | 75 | 71 | 77 | 83 | 81 | 70 | 76 | 81 | 77 |
| Average aspect ratio | 89 | 82 | 93 | 84 | 91 | 88 | 75 | 89 | 92 | 88 |
| Average layer thickness (Å) | 150 | 182 | 166 | 176 | 146 | 142 | 162 | 151 | 149 | 140 |
| Maximum layer thickness (Å) | 635 | 726 | 685 | 705 | 589 | 604 | 675 | 614 | 578 | 546 |
| Fineness (dtex) | 53 | 52 | 55 | 54 | 50 | 51 | 53 | 55 | 54 | 51 |
| Strength (cN/dtex) | 2.4 | 2.3 | 2.5 | 1.9 | 2.7 | 2.8 | 2.9 | 2.5 | 1.8 | 2.4 |
| Elongation (%) | 51 | 48 | 42 | 66 | 62 | 55 | 51 | 53 | 69 | 48 |
| Melting point (° C.) | 253 | 254 | 253 | 224 | 254 | 268 | 267 | 258 | 238 | 260 |
| | | | | 253 | | | | | | |
| Crystallinity (%) | 36 | 35 | 34 | 35 | 25 | 39 | 40 | 36 | 26 | 32 |
| Dripping resistance | ◯ | ◯ | ◯ | ◯ | ◯ | ◯ | ◯ | ◯ | ◯ | ◯ |

TABLE 6

| | Examples | | | | | | | | | |
|---|---|---|---|---|---|---|---|---|---|---|
| | 11 | 12 | 13 | 14 | 15 | 16 | 17 | 18 | 19 | 20 |
| Average of [D] (Å) | 2230 | 2480 | 2140 | 2480 | 2260 | 2290 | 2350 | 2160 | 2130 | 2290 |
| [N] (numbers/wt % · 100 μm²) | 40 | 78 | 76 | 85 | 86 | 89 | 73 | 78 | 85 | 87 |
| Average aspect ratio | 80 | 85 | 83 | 74 | 81 | 86 | 78 | 85 | 87 | 83 |
| Average layer thickness (Å) | 175 | 170 | 176 | 186 | 166 | 149 | 168 | 157 | 181 | 169 |
| Maximum layer thickness (Å) | 650 | 796 | 785 | 805 | 689 | 694 | 625 | 714 | 758 | 846 |
| Fineness (dtex) | 54 | 52 | 53 | 51 | 52 | 55 | 53 | 51 | 52 | 50 |
| Strength (cN/dtex) | 2.8 | 2.4 | 2.5 | 1.8 | 2.5 | 2.0 | 2.4 | 1.9 | 2.2 | 2.1 |
| Elongation (%) | 59 | 43 | 47 | 40 | 68 | 73 | 55 | 53 | 64 | 67 |
| LOI | 26 | 26 | 25 | 26 | 26 | 25 | 25 | 28 | 28 | 27 |
| Dripping resistance | ◯ | ◯ | ◯ | ◯ | ◯ | ◯ | ◯ | ◯ | ◯ | ◯ |

TABLE 7

| | Examples | | | | | | | | | |
|---|---|---|---|---|---|---|---|---|---|---|
| | 21 | 22 | 23 | 24 | 25 | 26 | 27 | 28 | 29 | 30 |
| Average of [D] (Å) | 3380 | 3260 | 3820 | 3290 | 3400 | 3410 | 3580 | 3360 | 3430 | 3390 |
| [N] (numbers/wt % · 100 μm²) | 62 | 65 | 51 | 68 | 60 | 63 | 49 | 64 | 59 | 61 |
| Average aspect ratio | 72 | 74 | 69 | 72 | 76 | 79 | 74 | 78 | 80 | 75 |
| Average layer thickness (Å) | 243 | 270 | 253 | 218 | 240 | 248 | 275 | 248 | 242 | 229 |
| Maximum layer thickness (Å) | 896 | 1025 | 839 | 915 | 907 | 928 | 1110 | 889 | 910 | 985 |
| Fineness (dtex) | 51 | 53 | 54 | 52 | 51 | 54 | 53 | 53 | 52 | 54 |
| Strength (cN/dtex) | 2.1 | 1.8 | 2.0 | 1.8 | 2.3 | 2.3 | 2.0 | 1.7 | 2.1 | 2.0 |
| Elongation (%) | 45 | 40 | 41 | 58 | 38 | 44 | 42 | 56 | 48 | 50 |
| LOI | 26 | 26 | 25 | 25 | 27 | 26 | 26 | 27 | 26 | 26 |
| Dripping resistance | ◯ | ◯ | ◯ | ◯ | ◯ | ◯ | ◯ | ◯ | ◯ | ◯ |

TABLE 8

| | Comparative Examples | | | |
|---|---|---|---|---|
| | 1 | 2 | 3 | 4 |
| Average of [D] (Å) | — | — | 26100 | 26210 |
| [N] (numbers/wt % · | — | — | 6 | 5 |
| 100 μm²) | | | | |
| Average aspect ratio | — | — | 1.5*¹ | 1.6*¹ |
| Average layer thickness (Å) | — | — | 31000*² | 30000*² |
| Average layer thickness (Å) | — | — | 850000*³ | 900000*³ |
| Fineness (dtex) | 49 | 52 | 55 | 55 |
| Strength (cN/dtex) | 2.5 | 2.3 | 2.2 | 2.2 |
| Elongation (%) | 64 | 78 | 48 | 48 |
| Melting point (° C.) | — | — | — | 253 |
| Crystallinity (%) | — | — | — | 31 |
| LOI | 20 | 26 | 25 | — |
| Dripping resistance | X | X | X | X |

*¹A ratio of major axis to minor axis of dispersed particles was determined because particles were not dispersed in a tabular form.
*²A number-average value of minor axis of dispersed particles was determined because particles were not dispersed in a tabular form.
*³A maximum value of minor axis of dispersed particles was determined because particles were not dispersed in a tabular form.

### Examples 31 to 33

A mixture of a thermoplastic polyester resin dried to water content of 100 ppm or less and a treated layer mixture shown in Table 9 was melt-kneaded using a twin screw extruder (TEX44, manufactured by Japan Steel Works Co., Ltd.) at a predetermined temperature of 230 to 320° C., pelletized and then dried to water content of 100 ppm or less. Using a no-bent type 30 mm single screw extruder (manufactured by Shinko Machinery Co., Ltd.), the molten polymer was ejected through a spinning spinneret provided with a round-section nozzle pore having a nozzle diameter of 0.5 mm, and then taken up at a take-up rate of 200 m/min while maintaining the temperature in a spinning column at 70° C. to obtain an undrawn yarn. The resulting undrawn yarn was drawn by 5 times in a warm water bath at 90° C., taken up at a take-up rate of 100 m/min using a heat roll heated to 180° C., and then subjected to a heat treatment to obtain polyester fibers having a single filament fineness of about 10 dtex.

### Examples 34 to 36

In the same manner as in Examples 31 to 33, except that a mixture of a thermoplastic polyester resin dried to water content of 100 ppm or less and a treated layer mixture shown in Table 9 was used and the take-up rate during spinning was replaced by 500 m/min, polyester fibers having a single filament fineness of about 3 dtex were obtained.

TABLE 9

| | Inherent | Examples | | | | | |
|---|---|---|---|---|---|---|---|
| | viscosity (IV) | 31 | 32 | 33 | 34 | 35 | 36 |
| Polyethylene | 0.85 | 90 | 90 | 90 | 90 | 90 | 90 |
| terephthalate*¹ | | | | | | | |
| Treated mica A | — | 10 | | | 10 | | |
| Treated mica B | — | | 10 | | | 10 | |
| Treated bentonite | — | | | 10 | | | 10 |

*¹Bellpet EFG-85A manufactured by Kanebo Gosen, Ltd.

TABLE 10

| | Examples | | | | | |
|---|---|---|---|---|---|---|
| | 31 | 32 | 33 | 34 | 35 | 36 |
| Average of [D] (Å) | 2200 | 2450 | 2215 | 2200 | 2450 | 2215 |
| [N] (numbers/wt % · | 85 | 75 | 71 | 85 | 75 | 71 |
| 100 μm²) | | | | | | |
| Average aspect ratio | 89 | 82 | 93 | 89 | 82 | 93 |
| Average layer thickness (Å) | 150 | 182 | 166 | 150 | 182 | 166 |
| Maximum layer thickness (Å) | 635 | 726 | 685 | 635 | 726 | 685 |
| Fineness (dtex) | 11 | 10 | 12 | 3 | 3 | 3 |
| Strength (cN/dtex) | 2.3 | 2.2 | 2.3 | 2.0 | 2.0 | 2.5 |
| Elongation (%) | 50 | 52 | 45 | 51 | 49 | 44 |
| Melting point (° C.) | 253 | 254 | 253 | 254 | 254 | 253 |
| Crystallinity (%) | 36 | 35 | 34 | 37 | 36 | 36 |
| Dripping resistance | ◯ | ◯ | ◯ | ◯ | ◯ | ◯ |

### INDUSTRIAL APPLICABILITY

The present invention provides a flame-retardant polyester fiber made of a polyester composition containing a thermoplastic polyester resin and a layer compound, which maintains fiber physical properties such as heat resistance, toughness, and is not melt-dripped during burning, and thus a polyester fiber having improved dripping resistance during burning can be provided.

1. A polyester fiber made of a polyester composition containing a layer compound treated with at least one kind selected from a polyether compound and a silane compound, and a thermoplastic polyester resin.

2. The polyester fiber according to claim 1, which further contains a phosphorus flame retardant.

3. The polyester fiber according to claim 1, wherein the thermoplastic polyester resin is a thermoplastic copolymer polyester resin copolymerized with a reactive phosphorus flame retardant.

4. The polyester fiber according to claim 1, wherein the polyether compound has a cyclic hydrocarbon group.

5. The polyester fiber according to claim 1, wherein the polyether compound is represented by the following general formula (1): 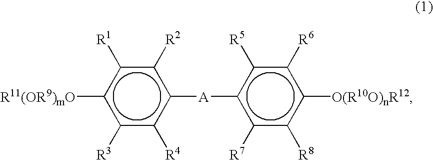
wherein -A- represents —O—, —S—, —SO—, —SO₂—, —CO—, an alkylene group having 1 to 20 carbon atoms, or an alkylidene group having 6 to 20 carbon atoms; any of R¹ to R⁸ represent a hydrogen atom, a halogen atom, or a monovalent hydrocarbon group having 1 to 5 carbon atoms; any of R⁹ and R¹⁰ represent a divalent hydrocarbon group having 1 to 5 carbon atoms; any of R¹¹ and R¹² represent a hydrogen atom or a monovalent hydrocarbon group having 1 to 20 carbon atoms, and may be the same or different; and m and n represent a repeating unit number of an oxyalkylene unit and satisfy the expression: 2≦m+n≦50.

6. The polyester fiber according to claim 1, wherein the silane compound is represented by the following general formula (2):
YnSiX₄₋ₙ (2)
wherein n represents an integer of 0 to 3; Y represents a hydrocarbon group having 1 to 25 carbon atoms, or an organic functional group composed of a hydrocarbon group having 1 to 25 carbon atoms and a substituent; X represents a hydrolyzable group and/or a hydroxyl group; and n Y and n X may be the same or different.

7. The polyester fiber according to claim 1, wherein an average layer thickness of the layer compound is 500 Å or less.

8. The polyester fiber according to claim 1, wherein a maximum layer thickness of the layer compound is 2000 Å or less.

9. The polyester fiber according to claim 1, wherein an average aspect ratio (ratio of layer length to layer thickness) of the layer compound in the resin composition is from 10 to 300.

10. The polyester fiber according to claim 1, wherein the layer compound is a layer silicate.

11. The polyester fiber according to claim 2, wherein the phosphorus flame retardant is at least one kind of a compound selected from the group consisting of a phosphate compound, a phosphonate compound, a phosphinate compound, a phosphine oxide compound, a phosphonite compound, a phosphinite compound, and a phosphine compound.

12. A polyester fiber made of a polyester composition comprising a layer compound treated with a water-soluble or water-miscible phosphorus flame retardant, and a thermoplastic polyester resin.

13. The polyester fiber according to claim 12, wherein an average layer thickness of the layer compound is 500 Å or less.

14. The polyester fiber according to claim 12, wherein a maximum layer thickness of the layer compound is 2000 Å or less.

15. The polyester fiber according to claim 12, wherein an average aspect ratio (ratio of layer length to layer thickness) of the layer compound in the resin composition is from 10 to 300.

16. The polyester fiber according to claim 12, wherein the layer compound is a layer silicate.

17. The polyester fiber according to claim 12, wherein the water-soluble or water-miscible phosphorus flame retardant is at least one kind of a compound selected from the group consisting of diethyl-N,N-bis(2-hydroxyethyl)aminomethylphosphonate, tris(hydroxyalkyl)phosphine, tris(hydroxyalkyl)phosphine oxides, alkyl-bis(hydroxyalkyl)phosphine oxides, alkyl-bis(hydroxycarbonylalkyl)phosphine oxides, dipolyoxyalkylenehydroxyalkyl phosphate, alkyl(hydroxycarbonylalkyl)phosphinic acids, and condensed phosphate esters.
